(19) United States
(12) Patent Application Publication
(10) Pub. No.: US 2025/0370391 A1
(43) Pub. Date: Dec. 4, 2025

(54) CALIBRATION DEVICE

(71) Applicant: Konica Minolta, Inc., Tokyo (JP)

(72) Inventors: Masahiko TAKAHASHI, Tokyo (JP); Daisuke KOBAYASHI, Tokyo (JP); Takafumi YUASA, Tokyo (JP)

(21) Appl. No.: 19/216,937

(22) Filed: May 23, 2025

(30) Foreign Application Priority Data
May 28, 2024 (JP) 2024-086431

(51) Int. Cl. G03G 15/00

(52) U.S. Cl. CPC G03G 15/6529; G03G 2215/00569; G03G 2215/00616

(57) ABSTRACT

A calibration device includes: a turner that turns, by a driving force from a driving source, within a range between a calibration position for calibrating the reference value and a retraction position retreated from the calibration position; and a switcher that switches a transmission state of the driving force from the driving source to the turner based on a turning position of the turner.

### CROSS REFERENCE TO RELATED APPLICATIONS

The present invention claims priority under 35 U.S.C. § 119 to Japanese patent Application No. 2024-086431, filed on May 28, 2024, the entire content of which is incorporated herein by reference.

### BACKGROUND

### Technological Field

The present invention relates to a calibration device.

### Description of Related Art

In the image forming device, fixing conditions and the like are different depending on the type of the recording medium, and therefore, settings are required for each type of the recording medium. In recent years, there have been image forming devices that automatically measure a characteristic of a recording medium using a sensor and change the setting. As a sensor for measuring the characteristics of the recording medium, an optical sensor is known which irradiates the recording medium with light, measures the amount of reflected light, and calculates the characteristics (moisture content and surface condition) of the recording medium.

A ratio, a difference, or the like of the light amount value from a reference value is used for the calculation of the characteristic of the recording medium. The reference value is a measured value based on a light amount reference plate that can be disposed on an optical path of a light source of the optical sensor. If the reference value varies due to factors other than the characteristic variation of the recording medium, aging of electrical components, temperature characteristics, and the like, the calculation of the characteristics of the recording medium is adversely affected. Therefore, it is necessary to frequently calibrate the reference value in order to measure the characteristics of the recording medium with high precision.

A light amount reference plate is known which is configured to be rotatable between a calibration position disposed on an optical path of a light source of an optical sensor and a retraction position retracted from the calibration position (see, e.g., Japanese Unexamined Patent Publication No. 2020-190420).

### SUMMARY

Incidentally, since the light amount reference plate turns only between the calibration position and the retraction position, the engaging position of the transmission gear that transmits the driving force to the light amount reference plate does not change in a series of turn operations by the calibration of the reference value. Therefore, when the reference value is frequently calibrated, the same gear teeth are continuously used, and thus the transmission gear is likely to be worn out due to long-term and frequent use. When the transmission gear wears, the posture and the position of the light amount reference plate vary, and consequently the measurement accuracy of the characteristics of the recording medium may deteriorate.

It is an object of the present invention to provide a calibration device capable of stabilizing the measurement accuracy of a reference value of an optical sensor.

In order to achieve at least one of the above-described objects, a calibration device reflecting one aspect of the present invention that calibrates a reference value of an optical sensor that measures a characteristic of a recording medium on a conveyance path, the calibration device including: a turner that turns, by a driving force from a driving source, within a range between a calibration position for calibrating the reference value and a retraction position retreated from the calibration position; and a switcher that switches a transmission state of the driving force from the driving source to the turner based on a turning position of the turner.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an image forming system including a calibration device according to an embodiment of the present invention;

FIG. 2 is a cross-sectional view illustrating a configuration of a measurement device;

FIG. 3 is a view of the housing from the +side in the Z direction;

FIG. 4 is a perspective view of a calibrator;

FIG. 5 is a view of the calibrator from the −side in the Z direction;

FIG. 6A is a diagram for explaining turning restriction of a turning member at a calibration position;

FIG. 6B is a diagram illustrating turning restriction of the turning member at a retraction position;

FIG. 7 is a diagram illustrating an engaging state of a transmitter at the calibrator;

FIG. 8 is a cross-sectional view illustrating a configuration of the measurement device with the calibrator at a calibration position; and

FIG. 9A to FIG. 9D are transition diagrams of an engaging position in the transmitter.

### DESCRIPTION OF EMBODIMENTS

Hereinafter, one or more embodiments of the present invention will be described with reference to the drawings. However, the scope of the invention is not limited to the disclosed embodiments.

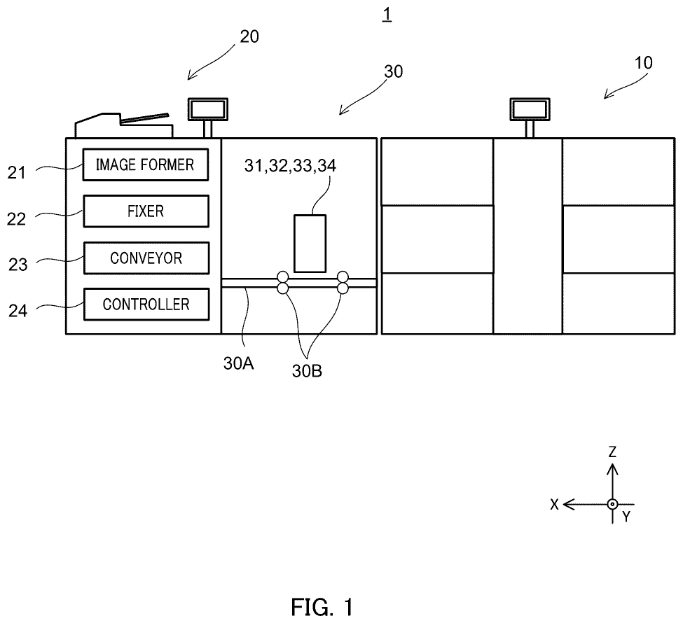

Hereinafter, an embodiment of the present invention will be described in detail with reference to the drawings. FIG. 1 is a block diagram illustrating an image forming system 1 including a calibration device according to an embodiment of the present invention.

In the description of the structures related to the calibration device of the present embodiment, a Cartesian coordinate system (X, Y, Z) is used. The drawings described below are also indicated with a common orthogonal coordinate system (X, Y, Z). The X direction indicates a conveyance direction of a recording medium conveyed by the calibration device, the Y direction indicates a direction parallel to the recording medium conveyed by the calibration device and orthogonal to the conveyance direction (a width direction of the recording medium), and the Z direction indicates an up-down direction of the calibration device.

As illustrated in FIG. 1, the image forming system 1 is a system capable of forming an image by measuring characteristics of a recording medium described later and changing settings of image forming conditions in accordance with the characteristics of the recording medium. The image forming system 1 includes a sheet feed device 10, an image forming device 20, and a measurement device 30.

The sheet feed device 10 includes, for example, multiple stages of sheet feeders therein, and feeds recording media one by one to the image forming device 20. In the sheet feeder, the recording medium identified on the basis of the basis weight, the size, or the like is stored.

The image forming device 20 is, for example, an intermediate transfer type color image forming device utilizing an electrophotographic process technology. Specifically, the image forming device 20 forms an image by performing primary transfer of toner images of each of colors of yellow (Y), magenta (M), cyan (C), and black (K) formed on a photosensitive drum to an intermediate transfer belt, overlapping the toner images of the four colors on the intermediate transfer belt, and then performing secondary transfer them to a sheet S fed from the sheet feed tray. Note that the image forming device 20 may be an image forming device of a type other than the intermediate transfer type.

The image forming device 20 includes an image former 21, a fixer 22, a conveyor 23, and a controller 24.

The controller 24 includes a central processor (CPU), a read only memory (ROM), a random access memory (RAM), and the like. The CPU reads a program according to processing contents from the ROM, develops the program in the RAM, and cooperates with the developed program to centrally control an operation of each block and the like of the image forming device 20.

The image former 21 forms an image (toner image) on a recording medium fed from the sheet feed device 10. The image former 21 includes image formers for forming images with color toners of a Y component, an M component, a C component, and a K component, and includes an intermediate transferor.

At the fixing nip, the fixer 22 heats and pressurizes the conveyed recording medium having the toner image transferred thereon, thereby fixing the toner image on the recording medium.

The conveyor 23 includes a conveyance path, a sheet ejector, and the like. The conveyance path includes a plurality of conveyance roller pairs such as a registration roller pair, and a normal conveyance path along which the recording medium is passed through the image former 21 and the fixer 22 and ejected to the outside of the image forming device 20.

The recording media stored in the sheet feed device 10 are delivered one by one from the top and are conveyed to the image forming device 20 via the measurement device 30. The recording medium conveyed to the image forming device 20 is conveyed to the image former 21 through the conveyance path. In the image former 21, the toner images on the intermediate transfer belt are collectively secondarily transferred to one surface side of the recording medium, and a fixing process is applied at the fixer 22. The recording medium with an image formed thereon is ejected to the outside of the device by the sheet ejector provided with a sheet ejection roller.

The measurement device 30 is disposed between the sheet feed device 10 and the image forming device 20, and includes a conveyance path 30A that connects the outlet of the recording medium of the sheet feed device 10 and the inlet of the conveyance path of the image forming device 20. Two conveyance rollers 30B disposed in the X direction are provided in the conveyance path 30A. The measurement device 30 is configured to be able to measure characteristics of recording media fed from the sheet feed device 10 to the conveyance path 30A.

The characteristic of the recording medium is, for example, the water content (moisture content) of the recording medium or the surface state of the recording medium. In the present embodiment, the characteristic of the recording medium is the moisture content of a recording medium P.

The measurement device 30 feeds back information on the measured characteristics of the recording medium to the image forming device 20 via a communicator (not illustrated). Thus, the image forming device 20 sets processing parameters of image forming conditions (fixing temperature and the like) in accordance with the information on the characteristics of the recording medium.

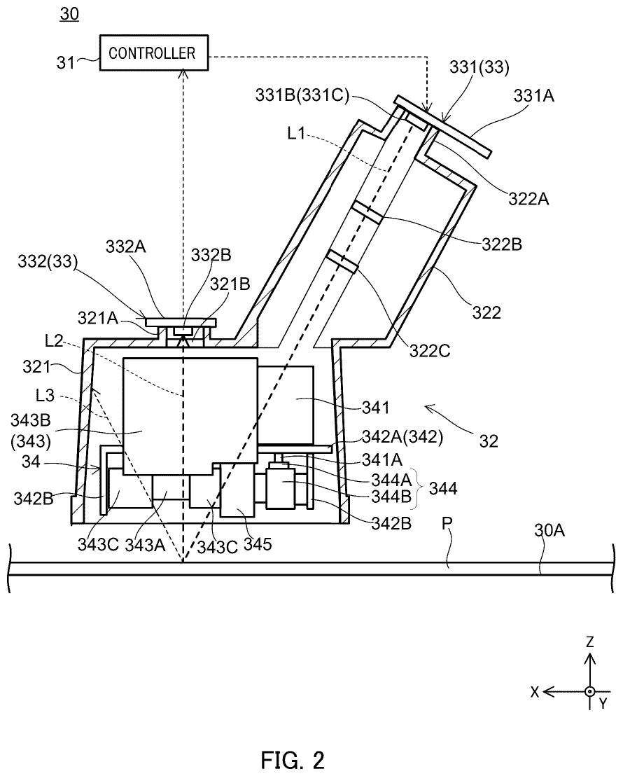

As illustrated in FIG. 2, the measurement device 30 includes a controller 31, a housing 32, a measurer 33, and a calibrator 34.

The controller 31 includes a CPU, a ROM, a RAM, and the like. The CPU reads a program according to processing contents from the ROM, develops the program in the RAM, and cooperates with the developed program to centrally control an operation of each block and the like of the measurement device 30.

The housing 32 is made of, for example, plastic, and is disposed to face the conveyance path 30A in the Z-direction. The housing 32 is provided with the measurer 33 and the calibrator 34.

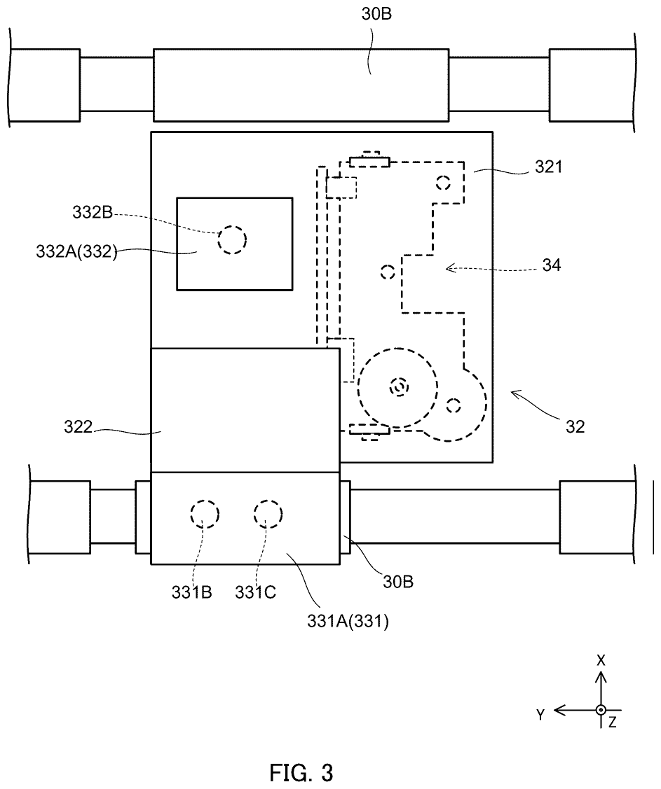

The housing 32 is located between the two conveyance rollers 30B (see FIG. 3). The housing 32 includes a first portion 321 and a second portion 322.

The first portion 321 is a portion that faces the conveyance path 30A, and is formed in a box shape with an opening on the −side in the Z direction. Through the opening portion of the first portion 321, light from the measurer 33 is emitted toward the recording media P on the conveyance path 30A, and light reflected from the recording media P returns into the housing 32.

An arrangement portion 321A where a light receiver of the measurer 33 (described later) is disposed is provided in an upper end portion of the first portion 321.

The second portion 322 is disposed on the −side in the X-direction (the upstream side in the conveyance direction) relative to the arrangement portion 321A at the end portion of the first portion 321 on the +side in the Z-direction, and extends from the end portion on the +side in the Z-direction toward the −side in the X-direction and the +side in the Z-direction. An arrangement portion 322A in which a light source 331 of the measurer 33 (described later) is disposed is provided at an end portion on the −side in the Z direction of the second portion 322.

The measurer 33 is an optical sensor that measures the characteristics of the recording medium P, and includes the light source 331 and a light receiver 332. The light source 331 includes a light source substrate 331A disposed at the arrangement portion 322A of the second portion 322. The light source substrate 331A is provided with a first light source 331B and a second light source 331C. The first light source 331B and the second light source 331C emit light under the control of the controller 31.

The first light source 331B is a LED chip corresponding to the absorption wavelength of water (e.g., 1450 nm). The second light source 331C is a LED chip corresponding to the non-absorption wavelength of water (e.g., 1300 nm).

As illustrated in FIG. 3, the first light source 331B and the second light source 331C are disposed side by side in the Y direction (the width direction of the recording media P). In other words, the plurality of light sources is provided side by side in a direction parallel to the conveyance surface of the recording medium P on the conveyance path 30A and in a direction orthogonal to the conveyance direction of the recording medium P.

The light receiver 332 includes a substrate 332A disposed at the arrangement portion 321A of the first portion 321 and a light receiving element 332B. The light receiving element 332B is, for example, a photodiode, and is disposed on a surface of the substrate 332A on one side in the Z direction.

Further, as illustrated in FIG. 2, a collimator lens 322B and an aperture 322C are provided in the optical path of the light from the light source 331 of the second portion 322 provided with the light source 331. In addition, a light receiving lens 321B is provided on the −side in the Z direction of the light receiver 332 of the first portion 321 where the light receiver 332 is provided.

Light L1 from the light source 331 is converted into substantially collimated light by the collimator lens 322B. Then, the light beam width is regulated by the aperture 322C, and the recording medium P in the conveyance path 30A is irradiated with the light L1. Thereafter, scattered reflection light L2 from the recording sheet P is focused on the light receiving element 332B at the light receiving lens 321B. Specular reflection light from the recording medium P is dominantly reflected at the surface of the recording medium P and does not contain information on the moisture content of the recording medium P, and therefore is not received by the light receiver 332.

Further, the respective reflected lights corresponding to the first light source 331B and the second light source 331C are received by the same light receiving element 332B in a time-division manner. In this manner, the moisture content of the recording medium P and its change are measured in real time and fed back to the image forming device 20, and thus the result of the feedback is reflected in the image forming conditions, thereby improving the image quality.

The moisture content of the recording medium P can be calculated based on a reference value measured in advance in a pre-shipment process or the like of the measurement device 30. The reference value is a value obtained by measuring, with the measurer 33, the amount of reflected light from a light amount reference plate (made of the same material as the light amount reference plate described later) placed on the recording medium surface with a jig or the like. The moisture content of the recording medium P is calculated based on the reference value and the amount of light reflected on the recording medium P conveyed in the measurement device 30. Specifically, the output based on the reference value is set as the moisture content of 0, and the amount of change from the reference value in the reflected light amount of the recording medium P is calculated as the moisture content of the recording medium P.

Further, as illustrated in FIG. 3, the detection region of the optical sensor (the region where the light receiving element 332B are located) in the conveyance path 30A is located at a position overlapping with the two conveyance rollers 30B in the Y direction. The position sandwiched between the two conveyance rollers 30B is a position where the posture of the recording medium P is stabilized, and thus the posture of the recording medium P in the detection region of the optical sensor is stabilized. As a result, the measurement by the measurer 33 can be stabilized.

Incidentally, the output of the reflected light amount fluctuates due to aging of electrical components, temperature characteristics, and the like. When the output of the reflected light amount fluctuates, the reference value based on the light amount reference plate also fluctuates. However, when the moisture content of the recording medium P is calculated using the reference value measured in the past, the calculated value does not become an accurate value due to the fluctuation of the reference value. Therefore, in the measurement device 30, calibration is performed by the calibrator 34 before the recording medium P reaches the measurement region of the measurer 33, such as at the start of a job.

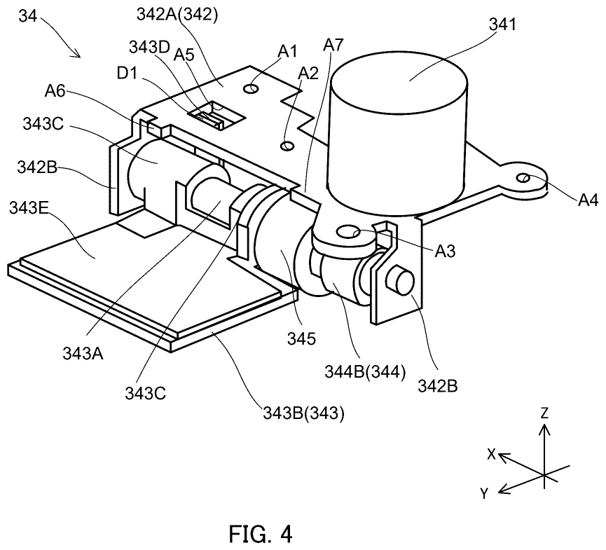

As illustrated in FIG. 4, the calibrator 34 measures the value (reference value) of the reflected light amount based on the light amount reference plate of the optical sensor in order to calibrate the reference value, and is accommodated in the first portion 321 of the housing 32. The calibrator 34 includes a driving source 341, a holder 342, a turner 343, a transmitter 344, and a switcher 345. The calibrator 34, the housing 32, and the controller 31 correspond to the “calibration device” of the present invention.

The driving source 341 is a motor including a drive shaft 341A (see FIG. 2). The driving source 341 is fixed on the holder 342. The driving source 341 is driven based on a control signal of the controller 31.

The holder 342 is formed of a plate-shaped metal member and holds the turner 343. The holder 342 has a main body 342A and a shaft supporter 342B.

The main body 342A is formed in a flat plate shape, and is disposed parallel to the XY plane. At an end of the main body 342A on the −side in the X direction, a hole (not illustrated) is provided through which a drive shaft 341A of the driving source 341 is passed. The driving source 341 is fixed on the main body 342A of the main body with the drive shaft 341A passed through the hole.

The main body 342A is provided with screw holes A1 to A4. The screw holes A1 to A4 are holes through which screws for fixing the holder 342 to the housing 32 are passed. The holder 342 is fixed to the fixing portion (not illustrated) of the first portion 321 of the housing 32 via the screw holes A1 to A4 with screws.

The screw hole A1 is located at an end portion of the main body 342A on the +side in the X direction.

The screw hole A2 is located on the −side in the X direction relative to the screw hole A1 and on the +side in the X direction relative to the driving source 341. The screw hole A3 is located at the end of the main body 342A on the −side in the X-direction and on the +side of the driving source 341 in the Y-direction. The screw hole A4 is located at the end of the main body 342A on the −side in the X-direction and on the −side in the Y-direction relative to the driving source 341.

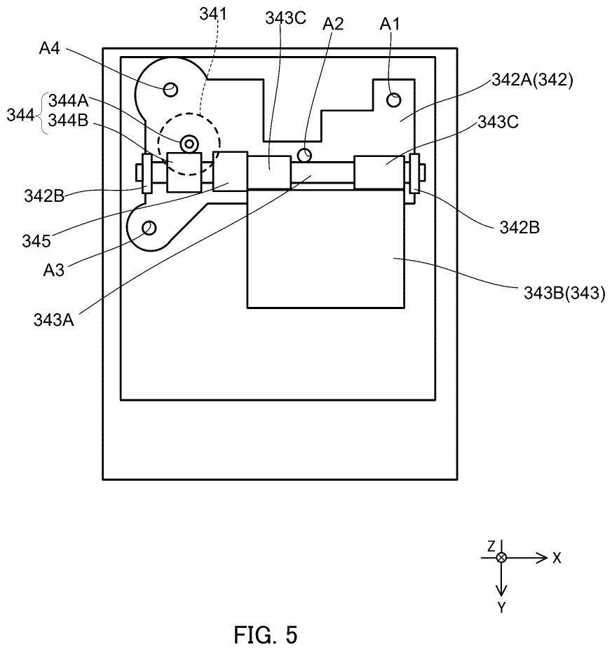

As illustrated in FIG. 5, the screw holes A2, A3, and A4 are located so as to surround the driving source 341. That is, the holder 342 is fixed to the housing 32 at a plurality of points surrounding the driving source 341. Further, the holder 342 may be fixed to the housing 32 so as to sandwich the housing 32 between the head of the screw and the holder 342 at least at one of the plurality of points.

Further, as illustrated in FIG. 4, a rectangular restriction hole A5 is provided at a position on the +side in the Y direction relative to the screw hole A1 of the main body 342A. The restriction hole A5 is a hole for restricting the turn of a turner 343 to the −side in the Z direction by contacting the turner 343 located at a calibration position described later. In other words, the restriction hole A5 restricts the turn of a turning member 343B to the downstream side relative to the calibration position in the direction from the retraction position toward the calibration position. The restriction hole A5 corresponds to a “first restrictor” of the present invention.

Further, restrictors A6 and A7 are provided at an end portion on the +side in the Y direction of the main body 342A. The restrictors A6 and A7 protrude from the main body 342A side to the +side in the Y direction, and are provided at positions corresponding to both end portions of the turner 343 in the X direction. The restrictors A6 and A7 restrict the turn of the turner 343 to the −side in the Y direction by contacting with the turner 343 located at the retraction position described later. In other words, the restrictors A6 and A7 restrict the turn of the turning member 343B to the downstream side relative to the retraction position in the direction from the calibration position toward the retraction position. The restrictors A6 and A7 correspond to the “second restrictor” of the invention.

The shaft supporter 342B is a portion that rotatably supports the turner 343, and is formed by bending both end portions of the main body 342A in the X direction.

The turner 343 is for calibrating the reference value of the optical sensor, and includes a turning shaft 343A and the turning member 343B. The turning shaft 343A is rotatably supported by the shaft supporter 342B of the holder 342, and is disposed parallel to the X direction.

The turning member 343B is a resin member formed in a rectangular plate shape. The turning member 343B is provided with an attached portion 343C to be attached to the turning shaft 343A. The attached portion 343C is formed in a tubular shape, and provided at a position corresponding to each of both end portions of the turning member 343B in the X direction. The turning member 343B, attached to the attached portion 343A with the attached portion 343C, turns around the turning shaft 343A.

Of the two attached portions 343C, the attached portion 343C on the +side in the X direction is provided at a position corresponding to the restriction hole A5 described above. The attached portion 343C on the +side in the X direction is provided with a contact portion 343D that protrudes to the +side in the Z direction when the turning member 343B is disposed parallel to the XY plane.

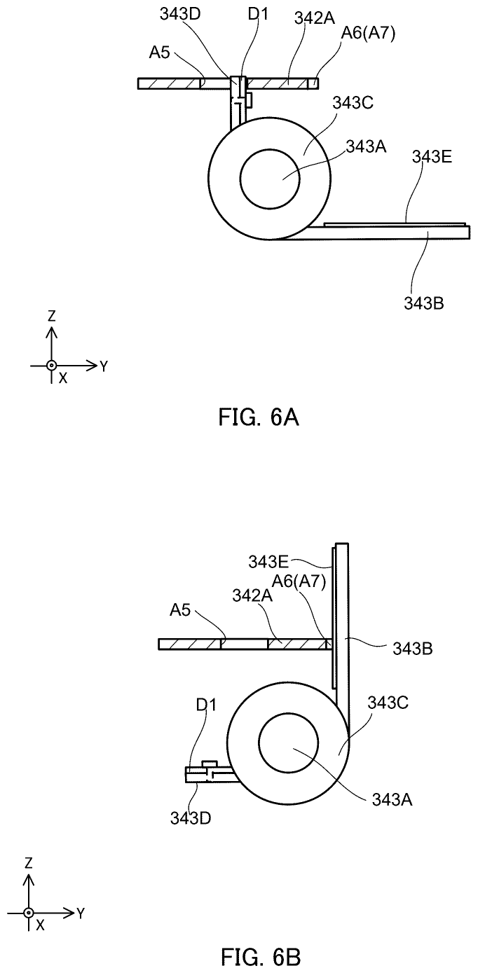

As illustrated in FIG. 6A, the contact portion 343D comes into contact with the surface of the restriction hole A5 on the +side in the Y direction. Accordingly, when the turning member 343B is disposed at a position (a calibration position described later) parallel to the XY plane, the turn of the turning member 343B to the −side in the Z direction is restricted.

In addition, a metal plate D1 is fixed with a screw to a portion that comes into contact with the wall surface of the restriction hole A5 of the contact portion 343D. In this manner, even if the contact portion 343D repeatedly comes into contact with the wall surface of the restriction hole A5, it is possible to suppress the wear of the contact portion 343D.

A light amount reference plate 343E is stuck on the front surface of the turning member 343B when the turning member 343B is disposed in parallel with the XY plane. The light amount reference plate 343E is made of the same material as the light amount reference plate used in measurement of the reference value (initial reference value) measured in advance in a pre-shipment process or the like, for example.

In addition, as illustrated in FIG. 6B, the turning member 343B comes into contact with the restrictors A6 and A7 of the holder 342 when disposed with the tip facing the +side in the Z direction. In this manner, when the turning member 343B is disposed with the tip end directed to the +side in the Z-direction, the turn of the turning member 343B to the −side in the Y direction is restricted.

The turning member 343B as described above is configured to turn in a range between the calibration position and the retraction position and not to turn to a position other than the range.

The calibration position is a position for calibrating the reference value of the optical sensor, and a position on the optical path of light output from the light source 331. In the present embodiment, the calibration position is a position at which the turning member 343B is disposed parallel to the XY plane.

The retraction position is a position retracted from the calibration position, and a position out of the optical path of light output from the light source 331. In the present embodiment, the retraction position is a position where the turning member 343B is disposed with the tip end directed to the +side in the Z-direction.

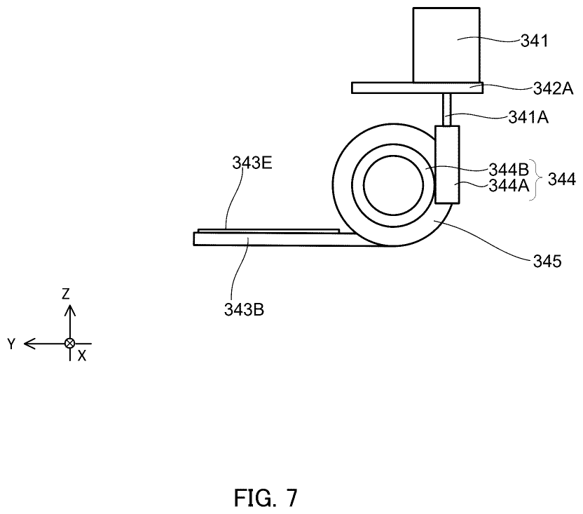

As illustrated in FIG. 5 and FIG. 7, the transmitter 344 is a gear mechanism that transmits the driving force of the driving source 341 to the turner 343, and is, for example, a worm gear. The drive shaft 341A of the driving source 341 is provided with a worm 344A, and the turning shaft 343A is provided with a worm wheel 344B. When the driving source 341 is driven, the driving force is transmitted to the turner 343 via the transmitter 344, and the turning member 343B turns.

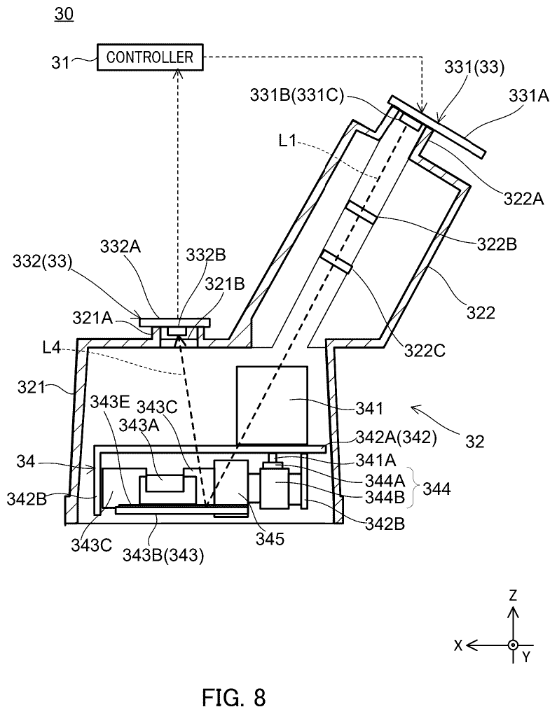

The turning member 343B is located at the calibration position when the reference value of the optical sensor is calibrated, and is located at the retraction position when image formation is performed by the image forming device 20. As illustrated in FIG. 8, when the turning member 343B is located at the calibration position, the light L1 from the light source 331 strikes the light amount reference plate 343E of the turning member 343B, and reflection light L4 is received by the light receiver 332. The reference value is calibrated based on the amount of reflected light received by the light receiver 332. The reference value is stored in a storage device (not illustrated), and when the reference value is calibrated, the reference value stored in the storage device is updated.

When the turning member 343B is at the retraction position, the light L1 from the light source 331 strikes the recording media P in the conveyance path 30A, and this reflection light L2 is received by the light receiver 332 as illustrated in FIG. 2. At this time, the moisture content of the recording medium P is calculated using the reference value stored in the storage device.

As illustrated in FIG. 5 and FIG. 7, the switcher 345 is, for example, a torque limiter, and switches between transmission and non-transmission of the drive force through the turning restriction of the restriction hole A5 and the restrictors A6 and A7. The switcher 345 is provided at the turning shaft 343A. The turning shaft 343A is configured such that a portion in which the turning member 343B is disposed and a portion in which the worm wheel 344B is disposed can be switched by the switcher 345 between a connected state and a disconnected state. That is, the switcher 345 is configured to be able to switch between transmission and non-transmission of the driving force of the driving source 341.

To be more specific, the switcher 345 switches the transmission state of the driving force from the driving source 341 to the turner 343 based on the turning position of the turning member 343B.

For example, when the turning member 343B is located within the range between the calibration position and the retraction position, the switcher 345 transmits the driving force of the driving source 341 to the turner 343. In addition, when the turning member 343B is located at the calibration position or the retraction position, the switcher 345 interrupts the transmission of the driving force of the driving source 341 to the turner 343.

In the present embodiment, in a case where the turning member 343B tries to turn to the −side in the Z direction from the calibration position, the restriction hole A5 and the contact portion 343D come into contact with each other, thereby increasing the torque to a relatively high level. Thus, the switcher 345 serving as a torque limiter interrupts transmission of the driving force of the driving source 341 to the turner 343. In addition, in a case where the turning member 343B tries to turn to the −side in the Y direction relative to the retraction position, the restrictors A6 and A7 come into contact with the turning member 343B, thereby increasing the torque to a relatively high level. Thus, the switcher 345 serving as a torque limiter interrupts transmission of the driving force of the driving source 341 to the turner 343.

In the present embodiment, in a predetermined case, the controller 31 controls the driving amount of the driving source 341 for the turning amount of the turning member 343B such that the turning member 343B exceeds the range between the calibration position and the retraction position. The predetermined case is at least one of a case where the turning member 343B turns from the calibration position toward the retraction position and a case where the turning member 343B turns from the retraction position toward the calibration position.

Specifically, the controller 31 controls the driving amount of the driving source 341 such that a first driving amount for turning the turning member 343B from the retraction position toward the calibration position and a second driving amount for turning the turning member 343B from the calibration position toward the retraction position are different from each other.

For example, although the turning angle in the range between the calibration position and the retraction position is 90 degrees, the controller 31 controls the driving amount of the driving source 341 by setting the turning angle corresponding to the first driving amount to 150 degrees and the turning angle corresponding to the second driving amount to 90 degrees. Since the difference between 150 degree and 90 degrees is 60 degrees, the driving force corresponding to at least 60 degrees is additionally applied to the turning member 343B in the turn from the retraction position toward the calibration position. In this case, the driving force for 60 degrees is regulated by the contact between the regulating hole A5 and the contact portion 343D.

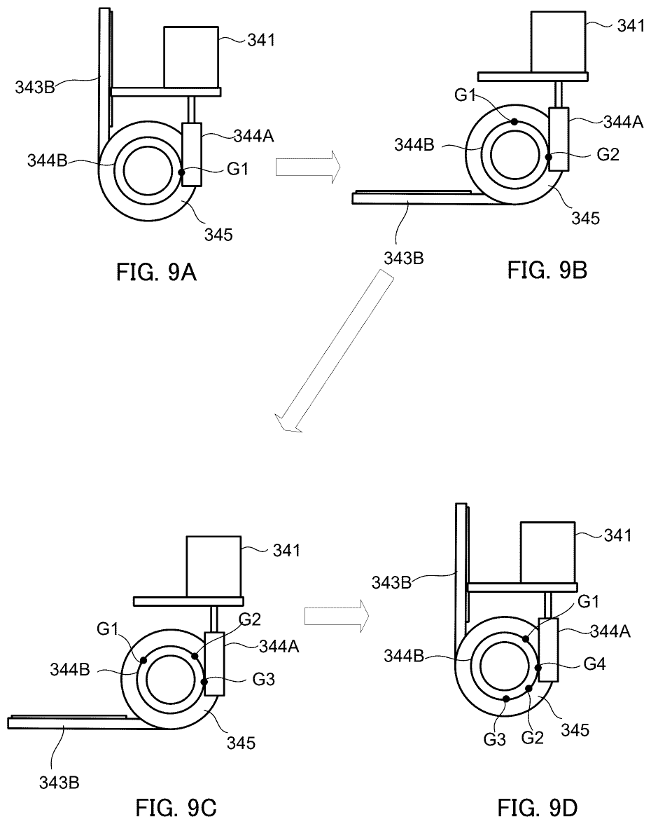

For example, as illustrated in FIG. 9, it is assumed that when the turning member 343B is located at the retraction position, the engaging position of the worm wheel 344B with the worm 344A is G1 (the state of FIG. 9A). In this case, when the turning member 343B turns from the retraction position toward the calibration position, the engaging position of the worm wheel 344B with the worm 344A moves from G1 to G2 (the state of FIG. 9B).

Here, for example, in a configuration in which the turning angles corresponding to the first driving amount and the second driving amount are both 90 degrees, the engaging position between the worm 344A and the worm wheel 344B does not change in the series of turn operations through the calibration of the reference value. In other words, only the portion of the worm wheel 344B between the G1 and the G2 corresponding to the range between the retraction position and the calibration position engages with the worm 344A. Therefore, since the gear teeth of the portion are continuously used each time the calibration is performed, the worm wheel 344B (transmission gear) is susceptible to wear.

In contrast, in the present embodiment, since the turning angle corresponding to the first drive amount is 150 degrees, the restriction hole A5 and the contact portion 343D come into contact with each other in the state of FIG. 9B. At this time, the switcher 345 interrupts the transmission of the driving force of the driving source 341 to the turning member 343B, and the worm wheel 344B further turns by 60 degrees with the turning member 343B stopped at the calibration position. Then, the engaging position of the worm wheel 344B with the worm 344A moves from the G2 to G3 (the state of FIG. 9C).

Further, when the turning member 343B turns from the calibration position toward the retraction position again, the engaging position of the worm wheel 344B with the worm 344A moves from the G3 to G4 because the angle corresponding to the second driving amount is 90 degrees (the state of FIG. 9D).

As a result, at the retraction position, the engaging position of the worm wheel 344B with the worm 344A is shifted from the G1 to G4. As such a turn operation is repeated, the engaging position is gradually shifted.

As a result, it is possible to prevent the continuous use of the same gear teeth of the worm wheel 344B, thereby preventing the transmission gear from becoming susceptible to wear due to prolonged and repeated use.

In the example illustrated in FIG. 9, the turning angle corresponding to the first driving amount is set to be larger than the turning angle corresponding to the second driving amount, but the turning angle corresponding to the second driving amount may be set to be larger than the turning angle corresponding to the first driving amount. Further, in the example illustrated in FIG. 9, the angle corresponding to the second driving amount is set to 90 degrees (the angle of the turning range of the turning member 343B), but may be set to be larger than the angle of the turning range.

Further, the absolute value of the difference between the turning angle of the turning member 343B based on the first driving amount and the turning angle of the turning member 343B based on the second driving amount may be a value other than the divisors of 360 degrees.

For example, it is assumed that the turning angle based on the first driving amount is set to 162.6 degrees and the turning angle based on the second driving amount is set to 156 degrees. In this case, the absolute value of the difference between the turning angle based on the first driving amount and the turning angle based on the second driving amount is 6.6 degrees. That is, the engaging position at the end of the series of turning operations is shifted by 6.6 degrees from the engaging position at the start of the turning operation.

Since 6.6 degrees is a number other than the divisors of 360 degrees, the transmission gear does not return to the initial engaging position of the transmission gear even if the series of turning operations is repeatedly performed, and thus the gear teeth of the transmission gear can be used evenly over the entire circumference.

In addition, since the switcher 345 is a torque limiter, it is possible to easily interrupt the transmission of the driving of the driving source 341 when the turn of the turning member 343B is restricted by the holder 342.

In the present embodiment configured as described above, it is possible to prevent the continuous use of the same gear teeth of the worm wheel 344B, thereby preventing the worm wheel 344B from becoming susceptible to wear due to prolonged and repeated use.

As a result, variation in the posture and position of the light amount reference plate is reduced, and the measurement accuracy of the reference value of the optical sensor can be stabilized, and thus, the measurement accuracy of the characteristic of the recording medium P can be stabilized.

Further, since the transmitter 344 is constituted by the worm gear including the worm 344A and the worm wheel 344B, the engagement is smoother as compared with a gear including spur teeth. As a result, it is possible to smoothly perform the operation at the start of the movement of the transmitter 344 and the operation in the switching of the driving.

Further, since the holder 342 is fixed to the housing 32 at a plurality of points surrounding the driving source 341, it is possible to reduce the influence of the vibration in the Z direction caused by the driving of the driving source 341 during the turning.

Further, the holder 342 may be made of metal, and may be fixed to the housing 32 so as to sandwich the housing 32 between the head of the screw and the holder 342 at least at one of the plurality of points. As a result, the metal holder 342 and the screw are engaged with each other to fix the holder 342, which makes it possible to firmly fix the holder 342 even when the housing 32 is made of resin.

In addition, since the metal plate D1 is fixed to the contact portion 343D that comes into contact with the restriction hole A5, it is possible to reduce impact and abrasion caused by the contact with the restriction hole A5 and thus reduce a change in the posture of the turning member 343B (light amount reference plate 343E).

Further, the turning member 343B turns with the turning shaft 343A that is parallel to the X direction, i.e., the optical axis. Therefore, when the turning member 343B is located at the retraction position, the turning member 343B can be disposed without intersecting with the optical axis, and thus it is possible to prevent a situation where specular reflection light or the like is reflected by the turning member 343B and received by the light receiver 332, for example. As a result, it is possible to suppress deterioration of measurement accuracy in the optical sensor.

A plurality of light sources is provided side by side in a direction (Y direction) parallel to the recording medium P on the conveyance path 30A and orthogonal to the conveyance direction of the recording medium P. Since the recording medium P is conveyed while being sandwiched between the two conveyance rollers 30B disposed side by side in the conveyance direction, there is a possibility that the posture of the recording medium P changes in the conveyance direction due to waving, inclination, or the like. In the present embodiment, since the two light sources are disposed side by side in the Y direction, the optical path lengths of the two light sources to the light receiver 332 can be made substantially the same. As a result, it is possible to reduce the influence on the output of the light receiving element 332B due to the posture fluctuation of the recording medium P during conveyance.

In addition, since the turning shaft 343A is parallel to the conveyance direction (X direction) of the recording medium P, it can be easily disposed between the two conveyance rollers 30B, and thus the entire device can be made compact. Further, since the distance between the two conveyance rollers 30B can be easily narrowed, even a small-sized recording medium P can be measured in a state where the recording medium P is sandwiched between the two conveyance rollers 30B.

In addition, since the detection region of the optical sensor is located at a position overlapping the two conveyance rollers 30B in the Y direction, it is possible to perform the measurement in the state where the posture of the recording medium P conveyed over the detection region is stable.

Note that while the switcher 345 is a torque limiter in the above embodiment, the present invention is not limited thereto, and for example, the switcher 345 may be a clutch such as an electromagnetic clutch. In this case, the controller 31 may control the switcher 345 to switch between transmission and non-transmission of the driving force based on the position of the turning member 343B.

Further, while the calibration device includes the controller 31 in the above-described embodiment, the present invention is not limited thereto, and for example, an external controller (the controller 24 of the image forming device 20) may control the driving source and the like.

Further, while the transmitter 344 is a worm gear in the above embodiment, the present invention is not limited thereto, and the transmitter 344 may be a gear mechanism other than a worm gear.

Further, while the driving source 341 is provided in the calibrator 34 in the above-described embodiment, the present invention is not limited thereto, and a configuration may be adopted in which a driving force of an external driving source is transmitted to the turner via an external transmission mechanism or the like.

While the metal plate D1 is provided at the contact portion 343D in the above-described embodiment, the present invention is not limited thereto, and the metal plate D1 may not be provided.

Further, in the above-described embodiment, no metallic member is provided in the portion of the turning member 343B that comes into contact with the restrictors A6 and A7, but the present invention is not limited thereto, and a metallic member may be provided.

While the calibration device is provided in the measurement device 30 provided separately from the image forming device 20 in the above-described embodiment, the present invention is not limited thereto, and for example, the calibration device (measurement device) may be provided in the image forming device. In this case, the calibration device may be provided on the upstream side relative to the image former.

In addition, each of the above-described embodiments is merely an example for embodying the present invention, and the technical scope of the present invention should not be interpreted in a limited manner by these embodiments. That is, the present invention can be implemented in various forms without departing from the spirit or main features thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. A calibration device that calibrates a reference value of an optical sensor that measures a characteristic of a recording medium on a conveyance path, the calibration device comprising:
a turner that turns, by a driving force from a driving source, within a range between a calibration position for calibrating the reference value and a retraction position retreated from the calibration position; and
a switcher that switches a transmission state of the driving force from the driving source to the turner based on a turning position of the turner.

2. The calibration device according to claim 1, wherein the switcher:
transmits the driving force to the turner when the turner is located within the range; and
interrupts transmission of the driving force to the turner when the turner is located at the calibration position or the retraction position.

3. The calibration device according to claim 2, further comprising:
a first restrictor that restricts turn of the turner to a downstream side relative to the calibration position in a direction from the retraction position toward the calibration position; and
a second restrictor that restricts turn of the turner to a downstream side relative to the retraction position in a direction from the calibration position toward the retraction position,
wherein the switcher is a torque limiter that switches between transmission and non-transmission of the driving force through turning restriction by the first restrictor and the second restrictor.

4. The calibration device according to claim 1, further comprising a hardware processor that controls a driving amount of the driving source such that a turning amount of the turner exceeds the range in at least one of a case where the turner turns from the calibration position toward the retraction position and a case where the turner turns from the retraction position toward the calibration position.

5. The calibration device according to claim 4, wherein the hardware processor controls the driving amount of the driving source such that a first driving amount by which the turner is turned from the retraction position toward the calibration position is different from a second driving amount by which the turner is turned from the calibration position toward the retraction position.

6. The calibration device according to claim 5, wherein an absolute value of a difference between a turning angle of the turner based on the first driving amount and a turning angle of the turner based on the second driving amount is a value other than a divisor of 360 degrees.

7. The calibration device according to claim 1,
wherein the turner includes a turning member on which a light amount reference plate is disposed, a transmission gear to which a driving force of the driving source is transmitted, and a turning shaft that turns the turning member, and
wherein the switcher switches a portion of the turning shaft where the turning member is disposed and a portion of the turning shaft where the transmission gear is disposed between a connected state and a disconnected state.

8. The calibration device according to claim 7,
wherein a drive shaft of the driving source includes a worm, and
wherein the transmission gear is a worm wheel that engages with the worm.

9. The calibration device according to claim 1, further comprising:
a holder to which the driving source is fixed and which rotatably holds the turner; and
a housing to which the holder is fixed,
wherein the holder is fixed to the housing at a plurality of points surrounding the driving source.

10. The calibration device according to claim 9, wherein the holder is made of metal, and is fixed to the housing at least at one of the plurality of points so as to sandwich the housing between a head of a screw and the holder.

11. The calibration device according to claim 3, wherein the turner includes a metal member that comes into contact with at least one of the first restrictor and the second restrictor when turn of the turner is restricted by the at least one of the first restrictor and the second restrictor.

12. The calibration device according to claim 1,
wherein the optical sensor includes a light source and a light receiver that receives light from the light source, and
wherein the turner turns with a turning shaft parallel to an optical axis of a light source of the optical sensor.

13. The calibration device according to claim 12, wherein a plurality of the light sources is provided side by side in a direction that is parallel to a conveyance surface of the recording medium in the conveyance path and is orthogonal to a conveyance direction of the recording medium.

14. The calibration device according to claim 12, wherein the turner turns with a turning shaft parallel to a conveyance direction of the recording medium in the conveyance path.

15. The calibration device according to claim 12,
wherein the calibration device is disposed at a position between two conveyance rollers that convey the recording medium in a conveyance direction of the recording medium in the conveyance path, and
wherein a detection region of the optical sensor in the conveyance path is located at a position overlapping the two conveyance rollers in a direction that is parallel to the recording medium in the conveyance path and is orthogonal to the conveyance direction of the recording medium.
